(19) United States
(12) Patent Application Publication
(10) Pub. No.: US 2004/0248564 A1
(43) Pub. Date: Dec. 9, 2004

(54) Method and system for processing an incoming telephone call for a subscriber by presorting the call based on signal information

(76) Inventors: Tiffany A. Moore, Omaha, NE (US); Mark Gullett, Monument, CO (US); John I. Ayers, Omaha, NE (US)

Correspondence Address: HEWLETT-PACKARD COMPANY, Intellectual Property Administration, P.O. Box 272400, Fort Collins, CO, 80527-2400, US

(21) Appl. No.: 10/456,547

(22) Filed: Jun. 9, 2003

(51) Int. Cl. H04M 3/42

(52) U.S. Cl. 455/417; 455/414.1

(57) ABSTRACT

A method and system are disclosed for processing an incoming call for a subscriber associated with a call processing system. The call processing system receives signal information for the incoming call and parses the signal information to try to determine whether the call is a data, fax, or speech call. The system determines whether the subscriber has the capabilities for handling the call type. If the subscriber has the required capabilities for handling the call, the system stores the call type for the call and thereafter processes the call based on the stored call type. In one example, the call is processed using supplemental services, such as call forwarding, by retrieving data for the supplemental service, where the data is specific to the call type.

### TECHNICAL FIELD

The technical field relates generally to the processing of incoming telephone calls for subscribers. More particularly, the technical field relates to a method and system for presorting incoming calls based on a call type for each of the calls.

### BACKGROUND

In a telephone network, such as a wireless telephone network, calls are -received by a call processing system for subscribers associated with the system. The call processing system then sends the received calls to the subscriber to whom the call is intended.

One problem with existing call processing systems is that subscribers may not have the capabilities for handling the incoming call. By way of example, incoming calls may be data, fax, or voice calls, but not all subscribers may be able to process all types of incoming calls. One subscriber might be able to process only voice calls, while other subscribers may be able to process all types of calls. Existing call handling systems assume that all incoming calls are speech calls. This requires subsequent processing if the subscriber does not have the capabilities required to handle the call. Also, if the call is not a speech call, data associated with the call may require additional processing to reformat the data to the proper call type. For example, if the subscriber is implementing supplemental services, such as call forwarding features, different call types may require different data or different data formats to implement the supplemental services. What is needed is a more efficient system for processing incoming calls.

### SUMMARY

A method is disclosed for processing an incoming call for a subscriber associated with a call processing system. The call processing system receives signal information for the incoming call and parses the signal information to try to determine whether the call is a data, fax, or speech call. The system determines whether the subscriber has the capabilities for handling the call type. If the subscriber has the required capabilities for handling the call, the system stores the call type for the call and processes the call based on the stored call type.

A call processing system is also disclosed for performing a method of processing an incoming call for a subscriber of the system. Signal information is received for the call to the subscriber. The signal information is parsed to determine a type of the call. The system determines whether the subscriber has capabilities for handling the call type and, if the subscriber has capabilities, the call type is stored. Thereafter, the call is processed based on the stored call type by retrieving data specific to the call type. In one embodiment, different data is stored in a subscriber information database for different call types, and the data specific to the call type is retrieved for the call, from the database.

A computer-readable medium is also disclosed having computer-executable instructions for performing a method for processing a call for a subscriber associated with a call processing system. Signal information is received for the call, and the instructions determine whether the signal information includes a bearer capability information element. If the signal information includes the bearer capability information element, then the bearer capability is checked for an information transfer capability for the call, and a call type is determined based on the information transfer capability.

### DESCRIPTION OF THE DRAWINGS

The detailed description will refer to the following drawings, wherein like numerals refer to like elements, and wherein:

FIG. 1 shows a block diagram of an embodiment of a call processing system that processes calls for subscribers of the system;

FIG. 2 shows a flow chart of an embodiment of processing an incoming call;

FIG. 3 shows a more detailed flow chart of one embodiment of processing an incoming call for a subscriber;

FIG. 4 shows an example format of bearer capability signal information element;

FIG. 5 shows an example format for the low layer compatibility information element;

FIG. 6 shows an example format for the high layer compatibility information element;

FIG. 7 shows a flow chart of one embodiment of parsing signal information;

FIG. 8 shows a flow chart of one embodiment of determining whether the call data is synchronous or asynchronous; and

FIG. 9 is an example data structure stored in the subscriber database containing data to be used for different call processing services.

### DETAILED DESCRIPTION

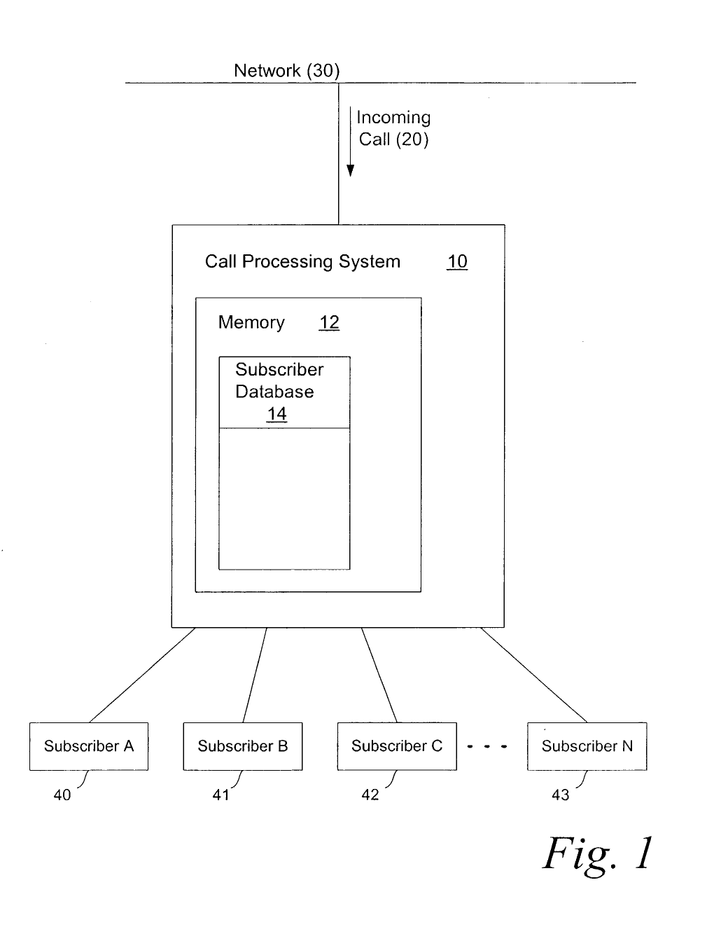

FIG. 1 shows a block diagram of an embodiment of a call processing system 10 that processes calls for subscribers 40-43 of the system 10. The call processing system 10 might be, for example, a home location register (HLR). The call processing system 10 includes a memory 12 that stores subscriber information in a database 14. The system 10 receives an incoming call 20 from a network 30, for one of the subscribers (e.g., Subscriber A 40). The network 30 may be a land-based or wireless network, and the subscribers may connect to the call processing system 10 by a land-based or wireless connection, or a combination thereof. In use, the system 10 determines the call type of the incoming call 20 by parsing signal information for the call. Based on the call type, the system 10 determines whether the subscriber for whom the call 20 is received (e.g., 40) has the required capabilities for handling the incoming call 20. For example, an incoming call might be either a voice (also referred to as “speech” or “telephony”) call, a data transmission, or a fax transmission. Certain subscribers (e.g., 40) may have service that allows them to receive all types of calls, while other subscribers (e.g., 41) may have limited service that allows them to receive only voice transmissions. In one embodiment, the subscriber information database 14 stores a table or other data structure that specifies subscriber rights, indicating which subscribers are subscribed to which services. The system 10 determines whether the subscriber (e.g., 40) has the capabilities for handling the incoming call 20 based on the subscriber rights stored in the database 14. The system 10 then stores the call type and processes the incoming call 20 based the subscriber's service activation for the call type.

In one embodiment, the call type is used to process calls in connection with a supplemental call processing service, such as a call forwarding or call barring service. Each type of supplemental service might use different data to process a call, for each different call type. For example, a call forward unconditional service uses data, including a call-forward number, to redirect the incoming call to the call-forward number. In this example, the data used by the call forward unconditional service might be different, or be in a different format, for different call types. A fax call might be forwarded to one call-forward number, while a voice call might be forwarded to a different number. Also, the call forwarding service might process the fax and voice calls differently, even if they are redirected to the same call-forward number. For example, the format of the data used to process fax calls might differ from the format used to process voice calls. In this example, the call forward unconditional data associated with the identified call type (e.g., voice, data, or fax) is retrieved from the subscriber database 14 and is used to process the incoming call. By determining the call type before processing the incoming call and by retrieving the data particular to the identified call type, the call processing system 10 does not have to later determine the call type from the data and does not later have to reformat the data according to the call type. The data retrieved for the call processing service is specific to the call type and therefore known to the call processing system 10 upon receiving the data.

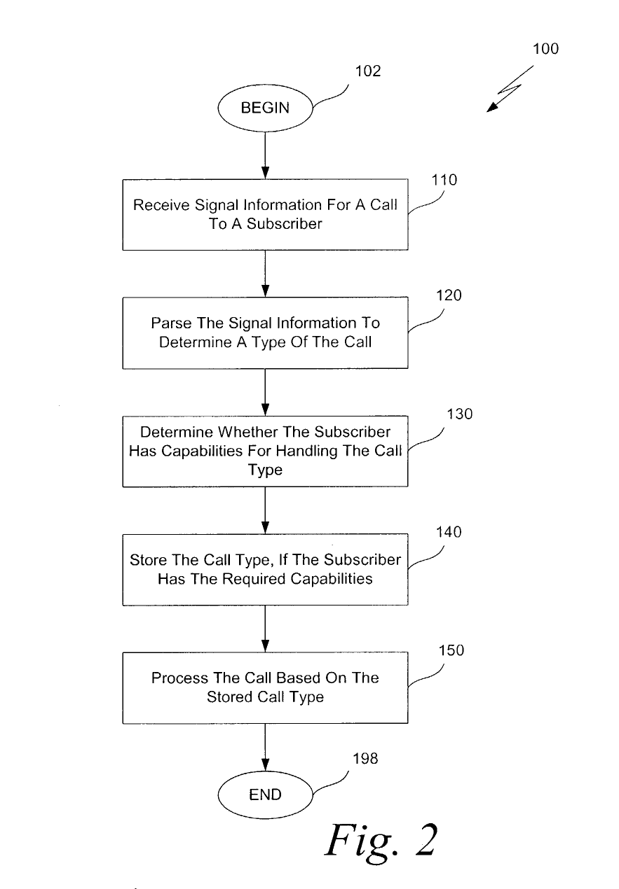

FIG. 2 shows a flow chart of an embodiment 100 of processing an incoming call. The method 100 begins 102 and signal information is received 110 for a call to a subscriber. The signal information is parsed 120 to determine the call type, and the system determines 130 whether the subscriber has capabilities for handling the call. The call type is stored 140 if the subscriber has the required capabilities, and the call is then processed 150 based on the stored call type, and the method 100 ends 198.

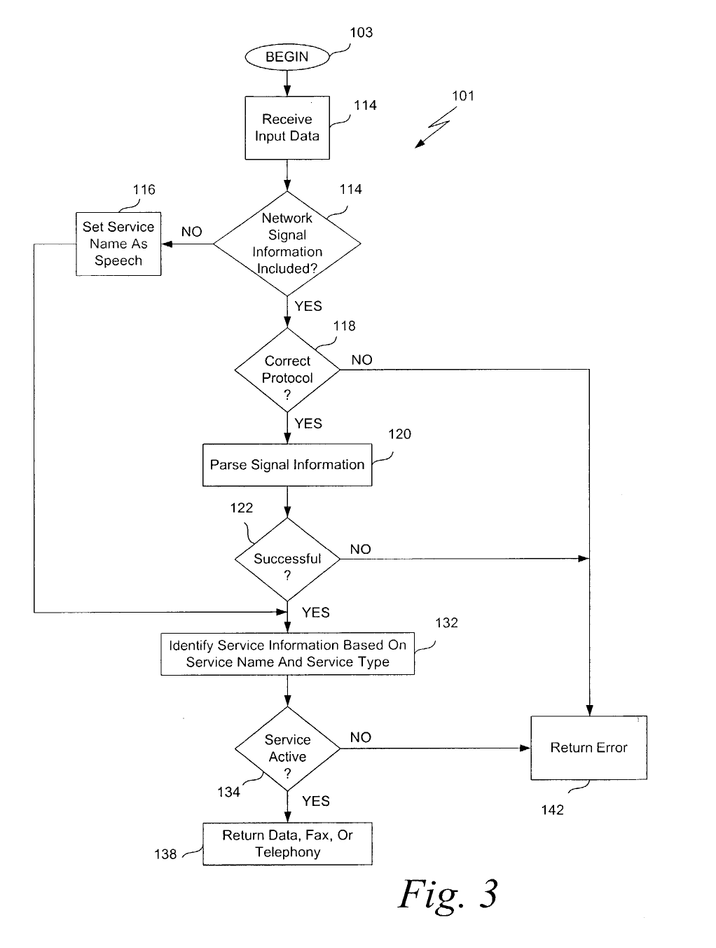

FIG. 3 shows a more detailed flow chart of one embodiment 101 of processing an incoming call for a subscriber. The embodiment 101 begins 103 and input data is received 112 for an incoming call 20. The input data may include, for example, data tokens associated with the incoming call 20. The system 10 determines 114 whether the input data includes network signal information. If network signal information is not included (“no” branch at block 114), then the service name for the incoming call is set to speech by default, and the system 10 proceeds to identify 132 the subscriber's service activation for the speech call.

If network signal information is included in the input data (“yes” branch at block 114), then the system 10 determines 118 whether the protocol of the incoming call 20 is correct. If the protocol is incorrect (“no” branch at block 118, then an error is returned 142 to indicate that the system 10 is not compatible with the protocol of the incoming call 20.

If the call 20 is of the correct protocol (“yes” branch at block 118), then the signal information is parsed 120 to determine the call service name and service type of the call 20. The system 20 determines 122 whether the parsing was successful. If the signal information was not successfully parsed (“no” branch at block 112)—that is, if the service name and service type cannot be identified for the call 20—then an error is returned 142. If the signal information is successfully parsed (“yes” branch at block 122), then the system 10 proceeds to determine whether the subscriber (e.g., 40) has the required service activation by identifying 132 service activation for the subscriber (e.g., 40) based on the service name and service type for the incoming call 20. In one embodiment, a table (not shown) stores service names and service types associated with all subscribers (e.g., 40-43) associated with the system 10, and the system 10 identifies service activation for the subscriber (e.g., 40) by looking up information in the table. After identifying 132 service activation for the subscriber (e.g., 40) , the system 10 determines 134 whether the service required by the incoming call 20 is activated for the subscriber (e.g., 40).

If service is activated for the subscriber (“yes” branch at block 134) for the incoming call 20, then the call type is identified as either data, fax, or telephony. This call type may then be stored (block 140 in FIG. 2) and used to process (block 150 in FIG. 1) the incoming call 20 for the subscriber (e.g., 40). If service for the incoming call 20 is not activated for the subscriber (“no” branch at block 134), then an error is returned 142.

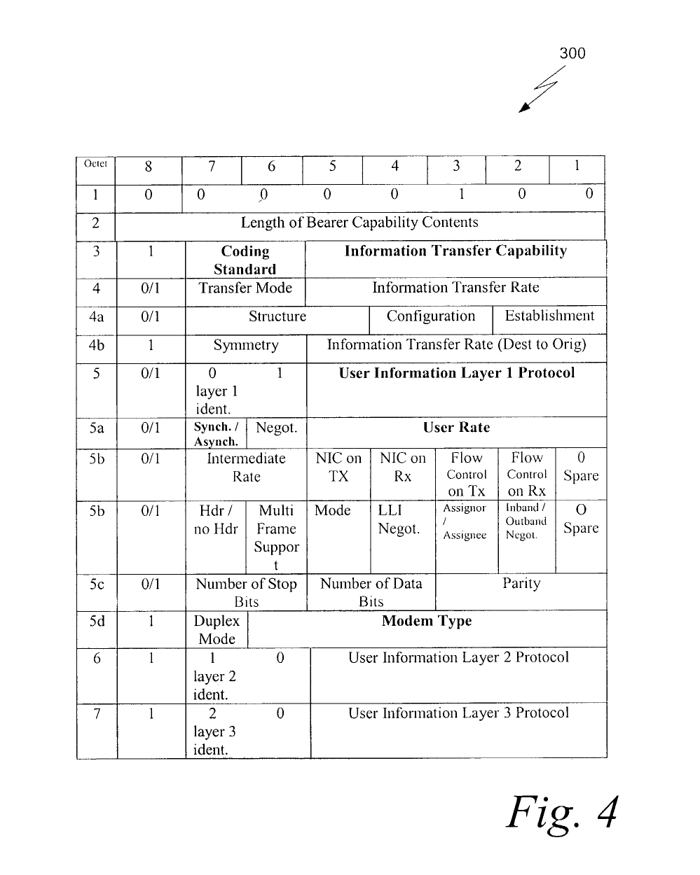

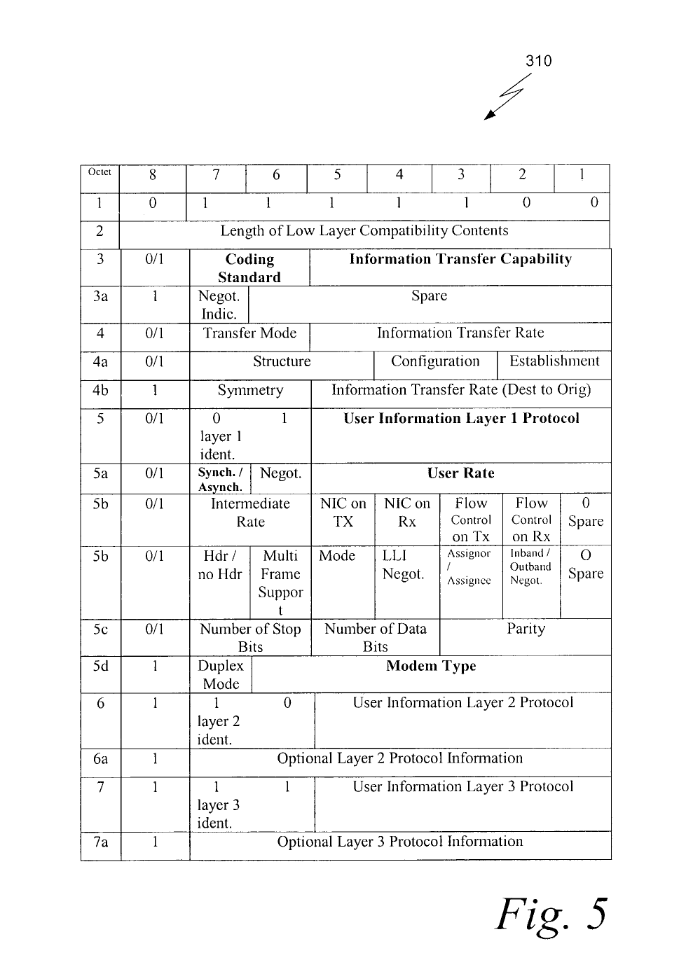

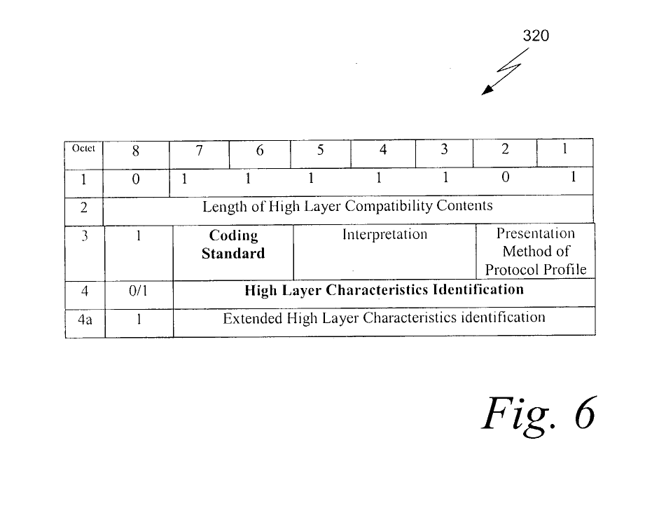

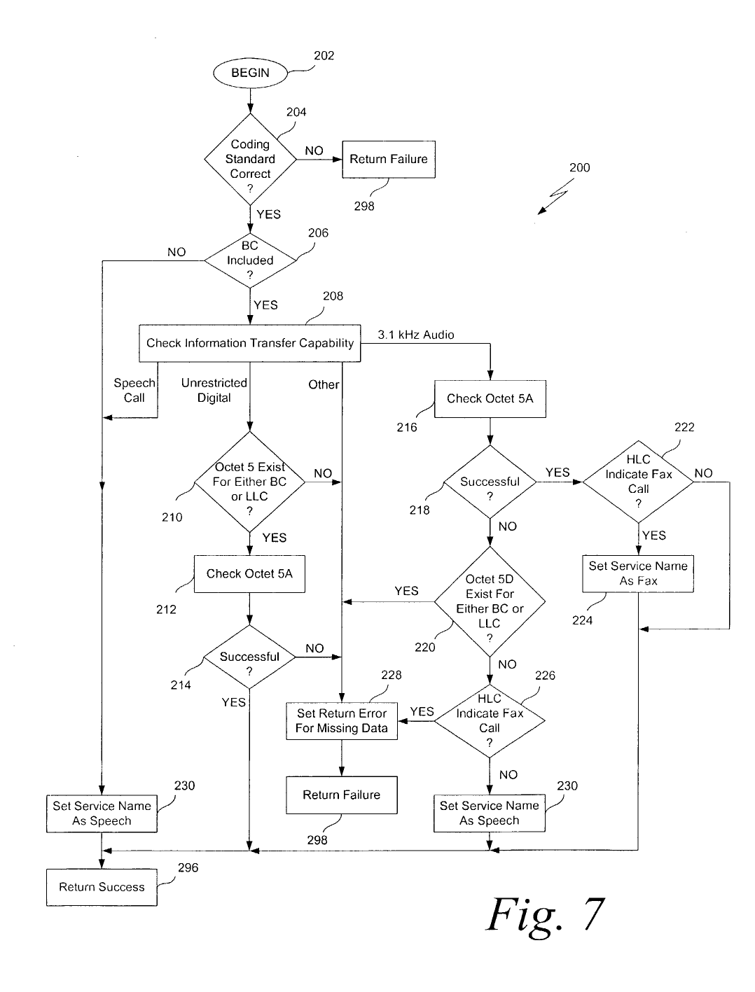

FIG. 7 shows a flow chart of one embodiment 200 of parsing signal information (block 120 in FIGS. 2 and 3). The signal information includes at least three information elements: bearer capability (“BC”), low layer compatibility (“LLC”), and high layer compatibility (“HLC”). FIG. 4 shows an example format of bearer capability signal information element 300. The bearer capability element 300 includes 8-bit data entries, referred to as “octets.” Information contained in the octets is parsed (block 120 in FIG. 3) to determine the call type. FIGS. 5 and 6 show example formats for the low layer compatibility information element 310 and the high layer compatibility information element 320, respectively.

Referring to FIG. 7, the example 200 begins 202, and ends by returning to the previous flow chart (e.g., block 120 in FIGS. 1 and 2) with either a “success” or “failure” indication, depending upon whether the signal information was successfully parsed. One embodiment of the example 101 shown in FIG. 2 uses the success/failure indication to determine (block 122 in FIG. 2) whether the system 10 was successful in parsing the signal information (block 120 in FIG. 2).

The system 10 determines 204 initially whether the coding standard for the signal information is correct. If the signal information is not encoded according to the correct standard (“no” branch at 204), then a failure is returned 298. If the coding standard is correct (“yes” branch at 204), then the system 10 determines 206 whether bearer capability (“BC”) is included in the signal information. If bearer capability is not included (“no” branch at block 206), then the service name is set to speech 230 by default, and a success indicator is returned 296.

If bearer capability is included in the signal information (“yes” branch at block 206), then the system checks the information transfer capability 208 to determine whether the information transfer capability indicates if the call is a voice call, an unrestricted digital transmission, a 3.1 kHz audio transmission, or another type of transmission. In one embodiment, the call processing system 10 checks the information transfer capability 208 by first checking to determine whether the bearer capability includes signal transfer information and, if the bearer capability does not include signal transfer capability, then checking the lower layer compatibility for signal transfer capability. The information transfer capability is a data field that may be contained in the bearer capability information element and/or the low level compatibility information element. In the example format of FIGS. 4 and 5, the information transfer capability is a 5-bit field contained in the third octet of both the bearer capability and the low level compatibility information elements. In one embodiment, a coding standard field, such as the two-bit field shown in FIGS. 4 and 5, is associated with the information transfer capability and must be set to a specified value (e.g., 00) to indicate a valid information transfer capability value. In one embodiment, calls are specified in the bearer capability element as follows: 00000=speech; 01000=unrestricted digital; 10000=3.1 kHz audio.

If the information transfer capability indicates that the call is a speech call, then no further analysis is undertaken in the example of FIG. 7, and the service name variable is set to identify the call as a speech call 230. The parsing is indicated to be successful 296 and the processing continues by determining the subscriber's capabilities for handling speech calls (e.g., block 130 in FIG. 2).

If the information transfer capability indicates that the call is an unrestricted digital call, then the system 10 determines 210 whether the data exists for octet 5 in either the bearer capability information element or the low layer compatibility element. If octet 5 exists in either the bearer capability element or the low layer compatibility element (“yes” branch at block 210), then the system checks 212 octet 5A of the bearer capability and/or the low layer compatibility to try to determine whether the data for the call is synchronous or asynchronous. If the system 10 is successful in checking octet 5A (“yes” branch at block 214), then a success indicator is returned 296. If the system 10 is not successful in checking octet 5A (“no” branch at block 214) or if octet 5 does not exist in either the bearer capability or the low layer compatibility for an unrestricted digital call (“no” branch at block 210), then a return error is set indicating missing data 228 and a failure indicator is returned 230.

If the information transfer capability indicates that the call is a 3.1 kHz audio call (block 208), then the system 10 tries to determine whether the call data is synchronous or asynchronous by checking octet 5A 216. If the system 10 is successful in checking octet 5A (“yes” branch at block 222), then the system 10 determines whether the high layer capability indicates that the call is a fax call 222. If the high layer compatibility indicates that the call is a fax call, then the service name is set as a fax 224 and a success indicator is set 296. If the high layer capability does not indicate that the call is a fax call, then no service name is set but a success indicator is set 296.

If the system 10 is unsuccessful in checking octet 5A (“no” branch at block 218), then the system 10 determines whether octet 5D exists in either the bearer capability information element or the low layer compatibility information element (220). If data does not exist in Octet 5D of either the bearer capability information element or the low layer compatibility information element, then the system 10 checks the high layer compatibility information element to determine whether the call 20 is indicated to be a fax call 226. If the call 20 is not indicated to be a fax call (“no” branch at block 226) by the high layer compatibility, then the service name is set to indicate a speech call 230, and the system 10 sets a success indicator and continues processing the call 296. If octet 5D does exist in either the bearer capability information element or in the low layer compatibility information element (“yes” branch at block 220) or if octet 5D does not exist and the high layer compatibility indicates that the call 20 is a fax call (“yes” branch at block 226), then a return error is set to indicate that data is missing 228 and a failure indicator is returned 298.

In the embodiment of FIG. 7, if the information transfer capability indicates that the call is something other than a speech call, an unrestricted digital call, or a 3.1 kHz audio call (“other” branch at block 208), then a return error is set 228, and a failure indicator is returned 298.

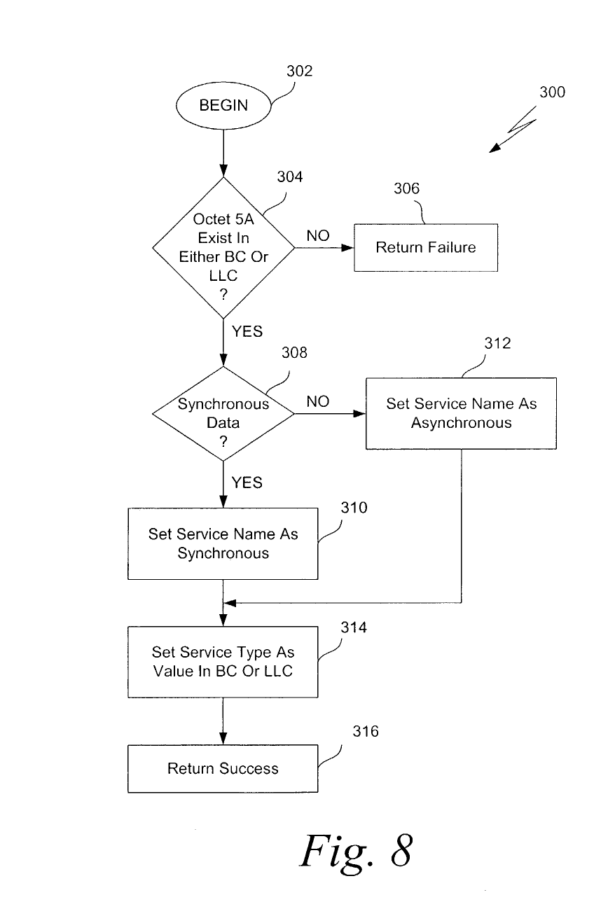

FIG. 8 shows a flow chart of one embodiment 300 for determining whether the call data is synchronous or asynchronous, as described, for example, at blocks 212 and 216 in FIG. 7. This example 300 begins 302 and the system 10 determines 304 whether octet 5A exists in either the bearer capability information element or in the low layer compatibility information element for the call 20. If octet 5A does not exist (“no” branch at block 304), then a failure is returned 306. If octet 5A exists in either the bearer capability information element or in the low layer compatibility information element (“yes” branch at block 304), then the system 10 determines 308 whether the data is synchronous or asynchronous based on the data value in octet 5A 308. For example, in the examples of FIGS. 4 and 5 bit 7, of octet 5A indicates whether the data is synchronous or asynchronous for the bearer capability information element and the low layer compatibility information element, respectively.

If the data is synchronous (“yes” branch at block 308), then the service name variable is set as synchronous 310. If the data is asynchronous (“no” branch at block 308), then the service name variable is set as asynchronous 312. For both asynchronous and synchronous calls, the service type variable is set as the value in the bearer capability information element or in the low layer compatibility information element 314, and a success indicator is returned 316.

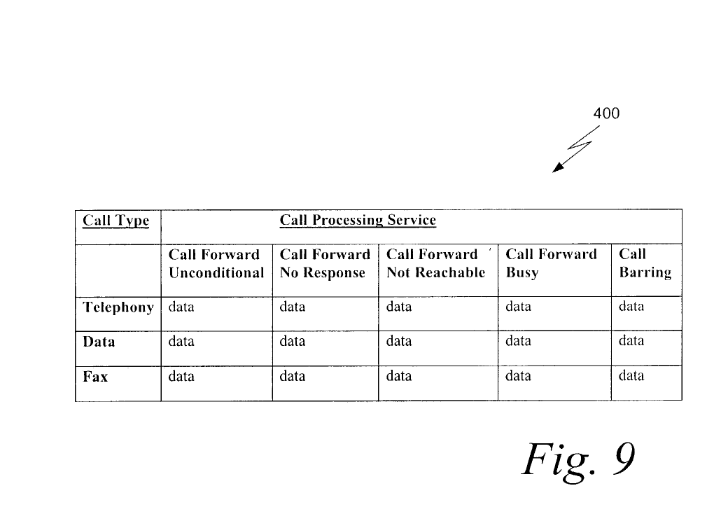

FIG. 9 is an example data structure 400 stored in the subscriber database 14, containing data to be used for different supplemental call processing services, such as call forwarding and call barring services shown. The data may be used by the call processing system 10 to process the incoming call 20, for example, by forwarding the call 20 to a call-forward number in the example of a call forwarding feature as the supplemental service. In the example of FIG. 9, data is stored for four types of call forwarding services in a table. Call forward unconditional refers to unconditional call forwarding. Call forward no response refers to call forwarding only when there is not response from the subscriber. Call forward not reachable refers to call forwarding that occurs only when the subscriber cannot be reached, for example, if the subscriber is outside of a service area. Call forward busy refers to a call forward feature that forwards calls only when the subscriber is busy with another call. Data is also included for call barring.

In the example of a call forwarding feature, the data includes, for example, a call-forward number, an indication of whether the subscriber is authorized to access the call forward service, and sub-address of the subscriber. In the case of a call barring feature, the data may indicate incoming call numbers that are barred. The data may vary for each of the different call processing services and for each of the different call types. For example, the data used to process telephony calls received while the call forward unconditional feature is active may be different than data stored to process fax calls while the call forward unconditional feature is active. For example, the different call forward numbers may be used for the different call types and/or the data used to process the different call types. Also, the data used to process telephony calls received while the call forward unconditional is active may differ from the data used to process telephony calls while the call forward no response or the call forward not reachable features are active.

After identifying the call type, the call processing system 10 retrieves the data corresponding to the call type and the call processing service. The incoming call 20 is then processed according to the received data. Because the retrieved data is specific to the call type, the call processing system 10 does not later need to determine the call type or reformat the data according to the call type. By determining the call type when the incoming call 20 is received, the call 20 is pre-sorted based on the call type. The retrieved data for call processing services, such as call forwarding services, is specific to the call type. Because the retrieved data is specific to the call type, the retrieved data and the incoming call 20 may be processed efficiently, in a generic manner for all call types, rather than later employing different processes to reformat a single set of data that applies to all call types, but requires additional processing based on the call type.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

1. A method of processing an incoming call for a subscriber by presorting the call based on a call type, the method comprising:
receiving signal information for the incoming call to the subscriber;
parsing the signal information to determine the call type of the call;
determining whether the subscriber has capabilities for handling the call type;
storing the call type, based on the determining; and
processing the call based on the stored call type.

2. The method of claim 1, wherein the step of receiving signal information comprises receiving information related to bearer capability, low level compatibility, and high level compatibility.

3. The method of claim 1, wherein the step of parsing comprises determining whether the signal information includes standard coding for bearer capability, low level compatibility, and high level compatibility.

4. The method of claim 1, wherein the step of parsing comprises identifying the call type using information stored in bearer capability codes in the signal information.

5. The method of claim 1, wherein the step of parsing comprises parsing to determine whether the call is a telephony call, a data call, or a fax call.

6. The method of claim 1, wherein the step of parsing comprises decoding bearer capability codes to determining whether the bearer capability codes indicate that the call is a telephony call, a data call, or a fax call.

7. The method of claim 1, wherein the step of determining comprises:
accessing a table that stores subscriber rights for the subscriber; and
comparing the call type to the subscriber rights.

8. The method of claim 1, wherein the step of processing comprises forwarding the call to a call-forward number specified for the subscriber, by retrieving data associated with the call-forward number, wherein the data is specific to the call type and using the retrieved data to forward the call.

9. A call processing system that performs a method of processing an incoming call for a subscriber of the system by presorting the call based on a call type, comprising:
a memory; and
a processor connected to the memory, wherein the processor executes instructions stored in the memory, for performing a method comprising:
receiving signal information for the call to the subscriber;
parsing signal information for the incoming call to determine the call type of the call;
determining whether the subscriber has capabilities for handling the call type based on information stored in a subscriber database;
storing the call type, based on the determining; and
processing the call based on the stored call type.

10. The system of claim 9, wherein the step of receiving signal information comprises receiving information related to bearer capability, low level compatibility, and high level compatibility.

11. The system of claim 9, wherein the step of parsing comprises decoding bearer capability codes contained in the signal information.

12. The system of claim 9, wherein the step of parsing comprises parsing to determine whether the call is a telephony call, a data call, or a fax call.

13. The system of claim 9, wherein the step of parsing comprises checking information transfer capability fields of bearer capability codes and low layer compatibility codes of the signal information to determine whether the call is a telephony call, a data call, or a fax call.

14. The system of claim 9, wherein the step of processing comprises processing the call according to a supplemental service activated for the subscriber by retrieving data from a subscriber database, wherein the data is specific to a call type.

15. The system of claim 14, wherein the step of retrieving data comprises retrieving a data element from the subscriber database, wherein the subscriber database contains a plurality of different data elements, wherein each of the data elements is associated with a supplemental service and with a call type, and wherein each of the data elements has a common format.

16. A computer-readable medium having computer-executable instructions for performing a method for processing a call for a subscriber associated with a call processing system, the method comprising:
receiving signal information for the call;
determining whether the signal information includes a bearer capability information element; and
if the signal information includes the bearer capability information element,
checking the bearer capability for an information transfer capability for the call;
determining a call type for the call based on the information transfer capability.

17. The medium of claim 16, wherein the method further comprises processing the call based on the call type, using data specific to the call type.

18. The medium of claim 16, wherein the step of checking the information transfer capability comprises determining whether the information transfer capability indicates that the call is a speech call, an unrestricted digital call, or a 3.1 kHz audio call.

19. The medium of claim 18,
wherein the method further comprises, if the information transfer capability indicates that the call is an unrestricted digital call, determining whether data exists in octet 5 of the bearer capability information element; and
wherein the step of determining the call type comprises, if data exists in octet 5, determining the call type based on a value specified in octet 5A of the bearer capability.

20. The medium of claim 18, wherein the method further comprises, if the information transfer capability indicates that the call is a 3.1 kHz audio call, checking a high layer compatibility information element to determine whether the call type is a fax call.

21. An apparatus for processing an incoming call for a subscriber of a call processing system, comprising:
means for receiving signal information for the incoming call for the subscriber;
means for determining a call type of the call, based on the signal information;
means for determining whether the subscriber has capabilities for handling the call type;
means for storing the call type if the subscriber has the capabilities; and
means for processing the call, after determining the call type, based on the stored call type.

22. The apparatus of claim 21, wherein the means for processing the call comprises:
means for retrieving data from a subscriber information database, wherein the data is associated with the call type for each of a plurality of different supplemental services; and
means for using the retrieved data to process the call according to the supplemental service.
